(19) United States
(12) Patent Application Publication
(10) Pub. No.: US 2025/0321347 A1
(43) Pub. Date: Oct. 16, 2025

(54) CORRELATION-BASED LOW-ORDER HARMONIC NOISE ATTENUATION METHOD

(71) Applicant: SAUDI ARABIAN OIL COMPANY, Dhahran (SA)

(72) Inventor: Jewoo YOO, Delft (NL)

(73) Assignee: SAUDI ARABIAN OIL COMPANY, Dhahran (SA)

(21) Appl. No.: 18/635,742

(22) Filed: Apr. 15, 2024

(51) Int. Cl. G01V 1/36

(52) U.S. Cl. CPC G01V 1/364

(57) ABSTRACT

A method for attenuating low order harmonic noise in recorded seismic data that includes receiving the recorded seismic data in response to vibroseis operations injecting a ground sweep into the Earth. The method further includes attenuating a fundamental order harmonic signal and a given harmonic signal of the ground sweep. Attenuating the given harmonic signal includes correlating the given harmonic signal of the ground sweep with the recorded seismic data and autocorrelating the given harmonic signal of the ground sweep. Attenuating the given harmonic signal further includes finding a matching time between the autocorrelated given harmonic signal and the given harmonic signal correlated with the recorded seismic data. Moreover, attenuating the given harmonic signal includes decorrelating the given harmonic signal of the ground sweep with the recorded seismic data based on the matching time to generate a decorrelated signal and subtracting the decorrelated signal from the recorded seismic data.

### FIELD OF THE DISCLOSURE

The present disclosure relates generally to signal processing and, more particularly, to attenuation of low-order harmonic signals.

### BACKGROUND OF THE DISCLOSURE

Seismic data acquisition is the first of the three distinct stages of seismic exploration, the other two being seismic data processing and seismic interpretation. Seismic acquisition requires the use of a seismic source at specified locations for a seismic survey, and the energy that travels within the subsurface as seismic waves generated by the source gets recorded at specified locations on the surface by what is known as receivers (geophones or hydrophones).

Before seismic data can be acquired, a seismic survey needs to be planned, a process which is commonly referred to as the survey design. This process involves the planning regarding the various survey parameters used, e.g. source type, receiver type, source spacing, receiver spacing, number of source shots, number of receivers in a receiver array (i.e. group of receivers), number of receiver channels in a receiver spread, sampling rate, record length (the specified time for which the receiver actively records the seismic signal) etc. With the designed survey, seismic data can be recorded in the form of seismic traces, also known as seismograms, which directly represent the “response of the elastic wave field to velocity and density contrasts across interfaces of layers of rock or sediments as energy travels from a source through the subsurface to a receiver or receiver array.”

Vibratory sources (also known as Vibroseis) are the most commonly used seismic sources in the oil and gas industry. An aspect that sets this type of source apart from explosives or other sources is that it offers direct control over the seismic signal transmitted into the subsurface i.e. energy can be transmitted into the subsurface over a known range of frequencies over a specified period of time. Vibratory sources typically host trucks that are mounted with heavy plates which repeatedly hit the ground to transmit seismic energy to the subsurface. Vibratory sources are often employed where vast areas need to be explored and where the acquisition region does not feature densely populated or densely vegetated areas; highly varying topography also inhibits the employment of vibratory sources.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for attenuating low order harmonic noise in recorded seismic data includes receiving the recorded seismic data in response to vibroseis operations injecting a ground sweep into the Earth based on a pilot sweep. The ground sweep and recorded seismic data include low order harmonic noise based on non-linearities associated with the vibroseis operations. The method further includes attenuating a fundamental order harmonic signal of the ground sweep and attenuating a given harmonic signal by correlating the given harmonic signal of the ground sweep with the recorded seismic data Attenuating the given harmonic signal is further performed by autocorrelating the given harmonic signal of the ground sweep. Attenuating the given harmonic signal is further performed by finding and selecting a matching time between the autocorrelated given harmonic signal and the given harmonic signal correlated with the recorded seismic data. Furthermore, attenuating the given harmonic signal is performed by decorrelating the given harmonic signal of the ground sweep with the recorded seismic data based on the matching time to generate a decorrelated signal. Additionally, attenuating the given harmonic signal includes subtracting the decorrelated signal from the recorded seismic data.

According to another embodiment consistent with the present disclosure, a machine-readable storage medium having stored thereon a computer program for attenuating low order harmonic noise in recorded seismic data, the computer program comprising a routine of set instructions for causing the machine to perform the step of receiving the recorded seismic data in response to vibroseis operations injecting a ground sweep into the Earth based on a pilot sweep. The ground sweep and recorded seismic data include low order harmonic noise based on non-linearities associated with the vibroseis operations. The routine of set instructions further cause the machine to perform the step of attenuating a fundamental order harmonic signal of the ground sweep and attenuating a given harmonic signal by correlating the given harmonic signal of the ground sweep with the recorded seismic data. Attenuating the given harmonic signal includes autocorrelating the given harmonic signal of the ground sweep. Attenuating the given harmonic signal further includes finding and selecting a matching time between the autocorrelated given harmonic signal and the given harmonic signal correlated with the recorded seismic data. Attenuating the given harmonic signal also includes decorrelating the given harmonic signal of the ground sweep with the recorded seismic data based on the matching time to generate a decorrelated signal. Additionally, attenuating the given harmonic signal includes subtracting the decorrelated signal from the recorded seismic data.

According to yet another embodiment consistent with the present disclosure, a vibroseis tool for attenuating low order harmonic noise in recorded seismic data. The vibroseis tool includes a vibroseis controller configured to receive the recorded seismic data in response to vibroseis operations injecting a ground sweep into the Earth based on a pilot sweep. The ground sweep and recorded seismic data include low order harmonic noise based on non-linearities associated with the vibroseis operations. The vibroseis tool further includes a vibroseis database operable to store the pilot sweep, ground sweep, and recorded seismic data. The vibroseis tool also includes a signal processor configured to attenuate a fundamental order harmonic signal of the ground sweep and a given harmonic signal by correlating the given harmonic signal of the ground sweep with the recorded seismic data. Attenuating the given harmonic signal includes autocorrelating the given harmonic signal of the ground sweep. Attenuating the given harmonic signal further includes finding and selecting a matching time between the autocorrelated given harmonic signal and the given harmonic signal correlated with the recorded seismic data. Further, attenuating the given harmonic signal includes decorrelating the given harmonic signal of the ground sweep with the recorded seismic data based on the matching time to generate a decorrelated signal. Attenuating the given harmonic signal also includes subtracting the decorrelated signal from the recorded seismic data in response to determining that a magnitude of the decorrelated signal is greater than a threshold value. Additionally, attenuating the given harmonic signal includes attenuating the given harmonic signal again in response to subtracting the decorrelated signal from the recorded seismic data.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of an example vibroseis system.

FIGS. 2A-C are examples of signals of the vibroseis system in the time domain.

FIGS. 3A-C are more examples of signals of the vibroseis system in the time-frequency domain.

FIGS. 4A is an example of recorded seismic data correlated with a fundamental order harmonic signal.

FIG. 4B is a prior art example of recorded seismic data correlated with a first order harmonic signal.

FIG. 5A is an example sweep wave in the time domain.

FIG. 5B is the example sweep wave auto-correlated in the time domain.

FIG. 6 is a flowchart of an example method for removing low-order harmonic noise from recorded seismic data.

FIG. 7 is examples of seismic data produced by the vibroseis system.

FIG. 8 is a computer system 800 that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to signal processing and, more particularly, to attenuation of low-order harmonic signals. Specifically, attenuation of low-order harmonic signals of recorded seismic data can be performed by a vibroseis tool configured to correlate and decorrelate harmonic signals with the recorded seismic data. The seismic data can be produced in response to vibroseis operations performed by a vibroseis truck with a metal plate. The vibroseis truck can inject a ground sweep signal, or a sinusoidal acoustic signal, into the Earth according to a pilot sweep signal. Ideally, the pilot sweep signal and ground sweep signal should match. However, the ground sweep signal includes noise or distortions due to non-linearities associated with the metal plate, as well as mechanical systems of the vibroseis truck. Because the seismic data is recorded in response to the ground sweep signal, the recorded seismic data includes noise associated with the non-linearities of the ground sweep signal. Furthermore, existing systems and methods that remove individual harmonic signals from recorded seismic data leave behind artifacts, or unwanted signals that misrepresent the true signal when correlating the seismic data with harmonic signals greater than the fundamental order harmonic signal. Therefore, the seismic data can include low-order harmonic noise from both non-linearities associated with vibroseis operations, as well as processing of the seismic data.

The vibroseis tool attenuates low-order harmonic noise in the seismic data by removing noise beginning with the fundamental order harmonic signal (e.g., zeroth order harmonic signal). For example, removing a first order harmonic signal and associated noise via existing correlation methods can leave strong artifacts associated with the low order harmonic signals, and more specifically, the fundamental order harmonic signal. Accordingly, the vibroseis tool removes the fundamental order harmonic signal and associated noise from the seismic data prior to removing the first order harmonic signal. Thus, the first order harmonic signal is removed from seismic data in a manner that does not result in artifacts associated with the fundamental order harmonic signal because the fundamental order harmonic signal is previously removed from the seismic data. Similarly, the second order harmonic signal can be removed from the seismic data subsequent to the first and fundamental order harmonic signal to produce seismic data without artifacts related to the first and fundamental order harmonic signals. Accordingly, this process can be repeated until all lower order harmonic signals are removed from the seismic data. In some examples, the number of low order harmonic signals can be the first to fifth order harmonic signals. In other examples, a user can select the n-th order harmonic signal to be removed to obtain an extended frequency range of seismic data. For example, if the user wants to obtain the frequency range of the data corresponding to the n-th order of harmonic signal, the signal corresponding from 0 (fundamental) to the n-1st order of harmonics must be removed from the raw seismic data before the correlation process with n-th order of harmonic signal.

Further, the vibroseis tool can remove a targeted harmonic signal from the seismic data by performing correlation and decorrelation. Specifically, the vibroseis tool can correlate the targeted harmonic signal with seismic data. Additionally, the vibroseis tool can auto-correlate the targeted harmonic signal, which creates an impulse of the targeted harmonic signal at a specific time. Accordingly, the vibroseis tool can find a matching point in time between the auto-correlated targeted harmonic signal and the seismic data correlated with the targeted harmonic signal. A shaping filter can be applied to the seismic data correlated with the targeted harmonic signal at the matching point in time found by the vibroseis tool. In response, the vibroseis tool can decorrelate the signal generated by the shaping filter from the targeted harmonic signal to produce a decorrelated signal. If the magnitude of the decorrelated signal is larger than a threshold based on the targeted order of harmonics, the decorrelated signal is substracted from the seismic data. Specifically, the threshold is for the energy of noise to be removed and can be a fixed value based on the recorded seismic data. For example, the threshold can be a fixed value of 2 percent, such that if the calculated noise energy exceeds 2% compared to the energy of the entire data, it will be removed This process of correlation and decorrelation can be repeated to remove the targeted harmonic signal until the magnitude of the decorrelated signal is less than the threshold. If the magnitude of the decorrelated signal is less than the threshold, another harmonic signal can be targeted for removal from the seismic data.

Because the vibroseis tool can remove noise associated with harmonic signals of the seismic data and artifacts associated with processing of the seismic data, the vibroseis tool can generate seismic data with an extended frequency range and higher accuracy compared to conventional systems. Specifically, the vibroseis tool can remove low order harmonic noise to reveal masked high frequency information of the recorded seismic data. Accordingly, more accurate seismic data can be employed by the vibroseis tool to deploy or alter oil recovery operations that rely on the seismic data. For example, the vibroseis tool can deploy equipment for extraction in response to determining that hydrocarbons are present beneath a surface characterized by the seismic data. Moreover, the vibroseis tool can deploy specific equipment based on seismic data that indicates advanced extraction techniques are required, such as horizontal drills.

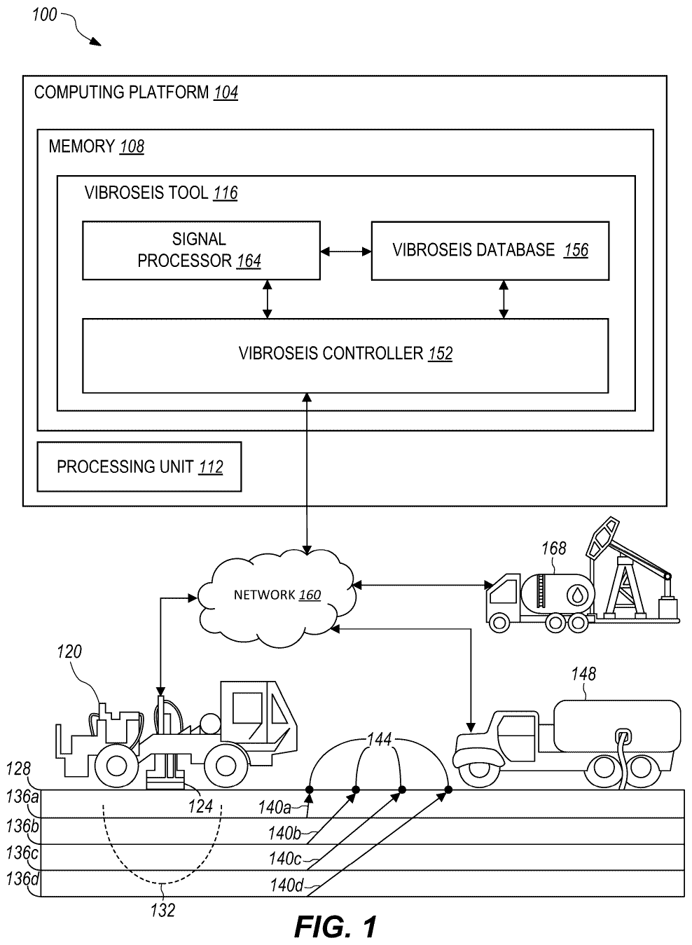

FIG. 1 is a block diagram of an example vibroseis system 100, which is configured to perform seismic data acquisition and processing. The vibroseis system 100 can include a computing platform 104 that further includes a memory 108 for storing machine readable instructions and data. The computing platform 104 can further include a processing unit 112 for accessing the memory 108 and executing the machine-readable instructions. The memory represents a non-transitory machine-readable memory (or other medium), such as random access memory (RAM), a solid state drive, a hard disk drive or a combination thereof. The processing unit 112 can be implemented as one or more processor cores. The computing platform 104 can further include a network interface (not shown), such as a network interface card configured to communicate with other components of the vibroseis system 100.

The computing platform 104 can be implemented in a computing cloud. In such a situation, features of the computing platform 104, such as the processing unit 112, the network interface, and the memory 108 can be representative of a single instance of hardware or multiple instances of hardware with applications executing across the multiple instances (e.g., distributed) of hardware (e.g., computers, routers, memory, processors, or a combination thereof). Alternatively, the computing platform 104 can be implemented on a single dedicated server or workstation. Furthermore, in some examples the computing platform 104 can be employed to implement other components of the vibroseis system 100 in a similar manner. However, for purposes of simplification of explanation, only the details of the computing platform 104 are shown.

The memory 108 can further include a vibroseis tool 116 for removing low-order harmonic noise from recorded seismic data. The seismic data can be recorded in response to a seismic device injecting a seismic signal into the ground or Earth. For example, the vibroseis system 100 can include a vibroseis truck 120 equipped with a metal plate 124 that is coupled to the surface 128 of the Earth or ground. Accordingly, the metal plate 124 can be used as a vibrator to inject a ground sweep 132 into the Earth at the surface 128, the ground sweep 132 being a time-variant sinusoidal acoustic signal. Below the surface 128 of the Earth can be layers 136 that each have a different property or formation. For example, a first layer 136a can be a sedimentary layer such as dirt, clay, sand, and/or gravel. A second layer 136b can be another sedimentary layer that has faults, whereas the first layer 136a lacks faults. A third layer 136c can be a subsurface shale formation, which can trap hydrocarbons beneath the shale formation. Thus, a fourth layer 136d can be a hydrocarbon reservoir of oil and/or natural gas.

In response to the ground sweep 132 traveling to each of the layers 136, a change in the layers 136 produces a respective reflective wave 140. Thus, the first layer 136a can produce a first reflective wave 140a, the second layer 136b can produce a second reflective wave 140b, the third layer 136c can produce a third reflective wave 140c, and the fourth layer 136d can produce a fourth reflective wave 140d. Each of these reflective waves 140 can be received by one or more of a plurality of sensors 144. The sensors 144 can be, for example, geophones, hydrophones, accelerometers, fiber-optic sensors, Micro-Electro-Mechanical Sensors (MEMS), or Distributed Acoustic Sensing (DAS) devices that are capable of detecting reflective waves. The type of sensor used can be based on the environment, such as land, shallow water, or even deep water, as well economic considerations.

Further, FIG. 1 illustrates four layers 136, reflective waves 140, and sensors 144 for the purpose of simplicity of explanation. Rather, a different number of layers 136, reflective waves 140, and sensors 144 can be present or produced by the vibroseis system 100. Moreover, the number of layers 136, reflective signals 140, and sensors 144 can be unequal. For example, the layers 136 can be non-uniform, interleaved, and/or sporadic. In another example, a gas hydrate can be lodged in a sedimentary layer such as the first or second layer 136a,b and liquid layers 136 such as the fourth layer 136 can have varying levels of density and fluid composition. Thus, the subsurface formations below the surface 128 can each produce one or more reflective waves 140 that can each be received by one or more sensors 144. Accordingly, the sensors 144 can generate seismic data characterizing the subsurface formations or layers 136 in response to receiving the reflective waves 140. The seismic data can recorded by the sensors 144 or be provided to another device, such as a recording truck 148, that records the seismic data. In some examples, the seismic data can be recorded by the same vehicle or device that produces the ground sweep 132.

The recorded seismic data can be provided to the vibroseis tool 116 by the recording truck 148, such that the vibroseis tool 116 can process the recorded seismic data and remove low order harmonics. Particularly, the vibroseis tool 116 can perform correlation and decorrelation of harmonic signals of the recorded seismic data to remove the low order harmonics and provide enhanced resolution to the seismic data. The vibroseis tool 116 can further generate and provide a signal to the vibroseis truck 120 to produce the sweep wave 130, as well as store the recorded seismic data for processing.

The vibroseis tool 116 can further include modules that execute specific operations to assist with these tasks. Specifically, the vibroseis tool 116 can include a vibroseis controller 152, which can be a software program that manages data and/or the flow of data, as well as resources of the vibroseis system 100. The vibroseis controller 152 can receive a pilot wave, or data characterizing the pilot wave, from a vibroseis database 156 of the vibroseis tool 116. Accordingly, the vibroseis controller 152 can provide the pilot wave to the vibroseis truck 120 to generate the ground sweep 132. In response, the vibroseis controller 152 can receive the recorded seismic data from the recording truck 148, for example, and provide the recorded seismic data to the vibroseis database 156. Accordingly, the vibroseis tool 116 can communicate over a network 160, such that the vibroseis controller 152 can communicate with the vibroseis truck 120 and recording truck 148 over the network. The network 160 can be an Internet Protocol version 6 (IPV6) network, 5G broadband network, a 4G Long Term Evolution (LTE) network, or local area network (LAN) compatible with Institute of Electrical and Electronics Engineers (IEEE) 802 Standards.

The vibroseis tool 116 can further includes a signal processor 164, which can receive the recorded seismic data from the vibroseis database 156 or the vibroseis controller 152. The signal processor can remove low-order harmonic noise from the recorded seismic data by correlating and decorrelating harmonic signals of the recorded seismic data. In an ideal situation, the pilot wave provided by the vibroseis controller 152 to the vibroseis truck 120 matches the ground sweep 132 injected into the Earth at the surface 128. However, inadequate coupling between the plate 124 and the surface 128 results in harmonic distortions in the ground sweep 132. Further, non-linearities associated with mechanical and hydraulic systems of the vibroseis truck 120 can also generate harmonic distortions in the ground sweep 132, which is therefore reflected in the recorded seismic data. Accordingly, the signal processor 164 can separate fundamental (e.g., harmonic order of zero) and higher order harmonics from the distorted ground sweep 132 to extend a frequency range of recorded seismic data by independently correlating the harmonics with raw seismic data.

Additionally, separating harmonic signals from the ground sweep 132 can leave artifacts that hinder imaging of the result of correlation between low order harmonic signals and the separated higher order signals of the ground sweep 132. Accordingly, the signal processor 164 removes such artifacts, or low order related harmonic noise based on a correlated relationship in the time and frequency domain. Conventional systems that attempt to remove distortions of the ground sweep 132 typically separate each order of harmonic signals compared to the pilot wave (e.g., the pilot wave provided by the vibroseis controller 152) and remove the lower orders, (e.g., orders 1-3). Because all orders of harmonics of the ground sweep 132 are real sources injected into the surface 128, the recorded seismic signal is affected by all harmonics. Therefore, the signal processor 164 can assume higher order harmonics as noise, which contain a wider range of frequency information. For example, when the fundamental order harmonic contains a frequency range of 2 to 150 Hertz (Hz), the signal processor can obtain seismic information in the 2 to 300 Hz range by correlating uncorrelated recorded seismic data with a separated first order harmonic signal. However, the seismic information having an extended frequency range (e.g., 2 to 300 Hz) is contaminated with fundamental order harmonic noise. Thus, a given harmonic signal can be removed by correlating the given harmonic signal with the recorded seismic data, such that the related energy is concentrated at a specific time and can be removed. All lower order harmonics can be removed by decorrelating the respective harmonics from the recorded seismic data. Specifically, the signal processor 164 can sequentially remove lower order harmonics to prevent artifacts in relatively higher order harmonic signals.

Thus, the signal processor 164 can produce more accurate seismic data from the ground sweep 132 and recorded seismic data, which can be stored in the vibroseis database 156. Moreover, information is obtained from seismic signals or harmonics that are treated as noise by conventional systems. While more information is obtained by correlating the separated higher-order harmonic signals within recorded seismic data, the signal processor 164 removes the lower-order harmonic related noise to make the information available. The additional information and increased accuracy (e.g., greater frequencies and less noise) of the recorded seismic data can be employed by the vibroseis controller 152 to deploy or alter operations of utility equipment 168. For example, accurate seismic data enables accurate mapping of a size and location of a reservoir (e.g., hydrocarbon reservoir of the fourth layer 136d), such that the vibroseis controller 152 can deploy utility equipment 168 based on the size and location of the reservoir. That is, a smaller reservoir may not support as many wells as a larger reservoir, and a larger reservoir could require additional utility equipment 168 for advanced extraction techniques, such as horizontal drilling.

Additionally, accurate seismic data enables accurate reservoir characterization, such as porosity, permeability, and the presence of faults, which can impact how the vibroseis controller 152 deploys utility equipment 168. That is, a reservoir without faults can have wells placed uniformly and employ standard recovery techniques, whereas a reservoir with faults requires targeted well placement to reach isolated pockets of hydrocarbons. Further, accurate seismic data enables accurate cost management, reductions in unnecessary drilling that impacts the environment, and mitigation of risks associated with drilling and extraction. In later stages of recovery, seismic data is also employed to monitor changes in reservoir characteristics over time, such that the vibroseis controller 152 can adjust extraction techniques and operations by utility equipment 168 based on the changes indicated by the seismic data.

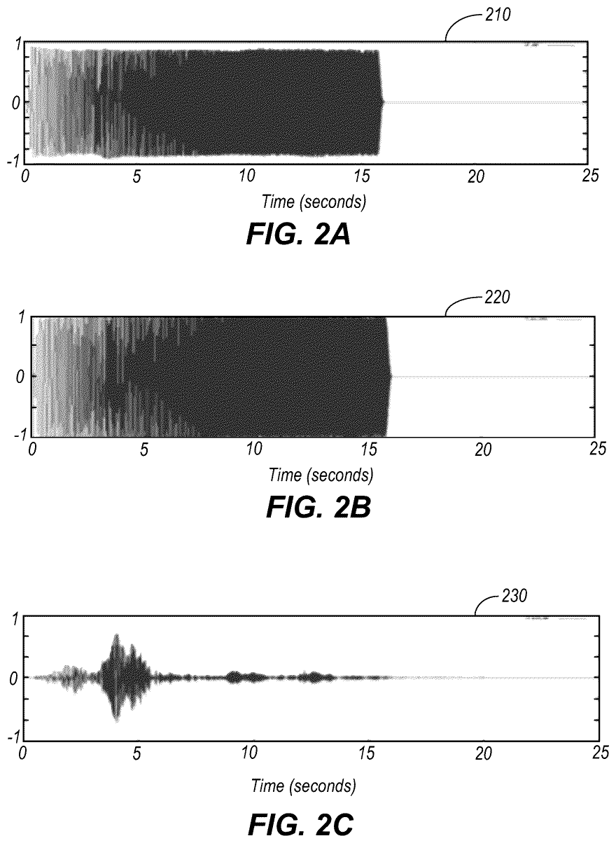

FIGS. 2A-C are example signals of the vibroseis system (e.g., vibroseis system 100 of FIG. 1) in the time domain. Specifically, FIG. 2A is an example pilot sweep 210, which can be the pilot wave that is provided by the vibroseis controller 152 to the vibroseis truck 120 of FIG. 1. That is, the pilot sweep 210 can be data characterizing the pilot wave stored in a vibroseis database 156 of the vibroseis tool 116 of FIG. 1. As illustrated, the pilot sweep 210 can last for approximately 16 seconds. In some examples, the pilot sweep 210 can be as short as 5 seconds or as long as 32 seconds. In other examples, the pilot sweep is generated by a seismic survey designer.

As previously stated, the pilot sweep 210 is the signal provided to a vibroseis truck 120 to be injected into a surface (e.g., surface 128 of FIG. 1) via a metal plate (e.g., plate 124). Accordingly, the metal plate can be oscillated at the frequency and duration of the pilot sweep 210 as illustrated in FIG. 2A. However, the wave provided to the ground is not equal to the pilot sweep 210 because of non-linearities associated with the coupling of the metal plate to the ground, as well as the mechanical and hydraulic systems of the vibroseis truck. Rather, FIG. 2B illustrates a ground sweep 220, which can be the ground sweep 132 of FIG. 1. That is, the ground sweep 220 is the signal actually provided to the surface of the Earth. Thus, the ground sweep 220 is not equal to the pilot sweep 210 because of the non-linearities associated with the vibroseis truck and metal plate. Although the ground sweep 220 can be similar to the pilot sweep 210, for example have the same duration, the ground sweep 220 includes the non-linearities as noise.

FIG. 2C illustrates recorded seismic data 230, which can be the recorded seismic data provided to the vibroseis controller 152 by the recording truck 148 or the sensors 144 of FIG. 1. As illustrated, the recorded seismic data 230 can be a sinusoidal response to the ground sweep 220, such that the recorded seismic data is a sinusoidal signal that has the same duration. However, the recorded seismic data 230 is a function of the ground sweep 220 reflecting off of layers 136 beneath the surface 128, such as the reflective waves 140 of FIG. 1. Furthermore, the recorded seismic data 230 can be raw, such that the recorded seismic data 230 has not been correlated by the signal processor 164 of FIG. 1. Additionally, the recorded seismic data 230 and sweeps 210,220 can be converted to a time-frequency domain.

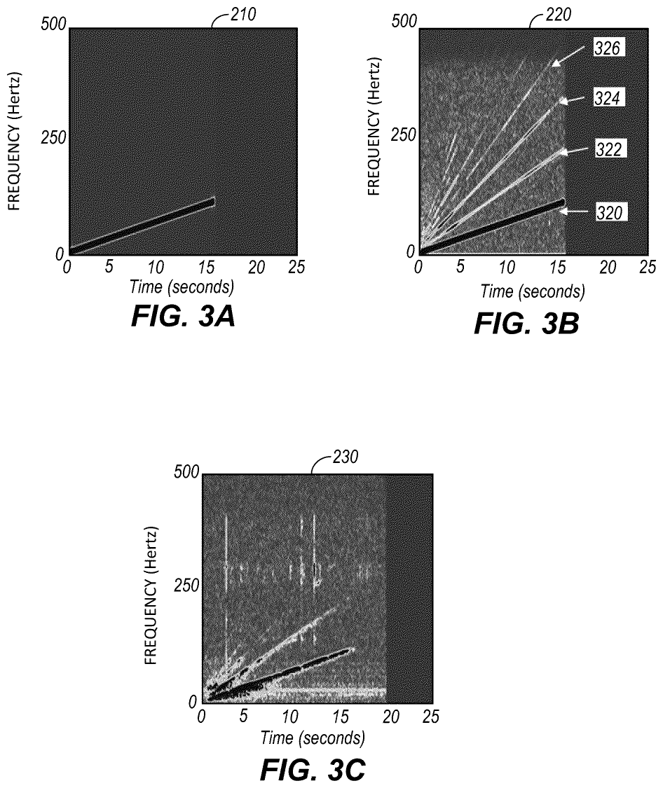

FIGS. 3A-C are example signals of the vibroseis system (e.g., vibroseis system 100 of FIG. 1) in the time-frequency domain. For example, FIG. 3A can be the pilot sweep 210 converted from the time domain of FIG. 2A to the time-frequency domain via a Gabor transformation. As illustrated, the pilot sweep 210 of the time-frequency domain has the same duration as the pilot sweep in the time domain (e.g., approximately 16 seconds), but has a linearly increasing frequency over that time. The frequency range can be computed from the sampling rate, such that the frequency range is the Nyquist frequency. Here, the sampling rate is 0.001 seconds, such that the frequency range is 500 Hz. Similarly, FIG. 3B is the ground sweep 220 converted from the time domain of FIG. 2B to the time-frequency domain via the Gabor transform. As illustrated in FIG. 3B, the ground sweep 220 converted to the time-frequency domain renders a plurality of signals, which are harmonic signals. For example, a fundamental order harmonic signal (H₀) 320 of the ground sweep 220 of FIG. 2B is illustrated as having a similar plot to the ground sweep 220 in the time domain of FIG. 2B. However, the plurality of signals further includes a first order harmonic signal (H₁) 322, a second order harmonic signal (H₂) 324, and a third order harmonic signal (H₃) 326. Other higher order harmonics of FIG. 3B are difficult to visualize because of noise or disturbances in the ground sweep 220.

FIG. 3C illustrates the recorded seismic data 230 converted from the time domain of FIG. 2C to the time-frequency domain. Because the recorded seismic data 230 is in response to the ground sweep 220, FIG. 3C also illustrates a plurality of signals including the fundamental order harmonic signal 320 and the first order harmonic signal 322. Again, however, the higher order harmonic signals are difficult to visualize because of noise.

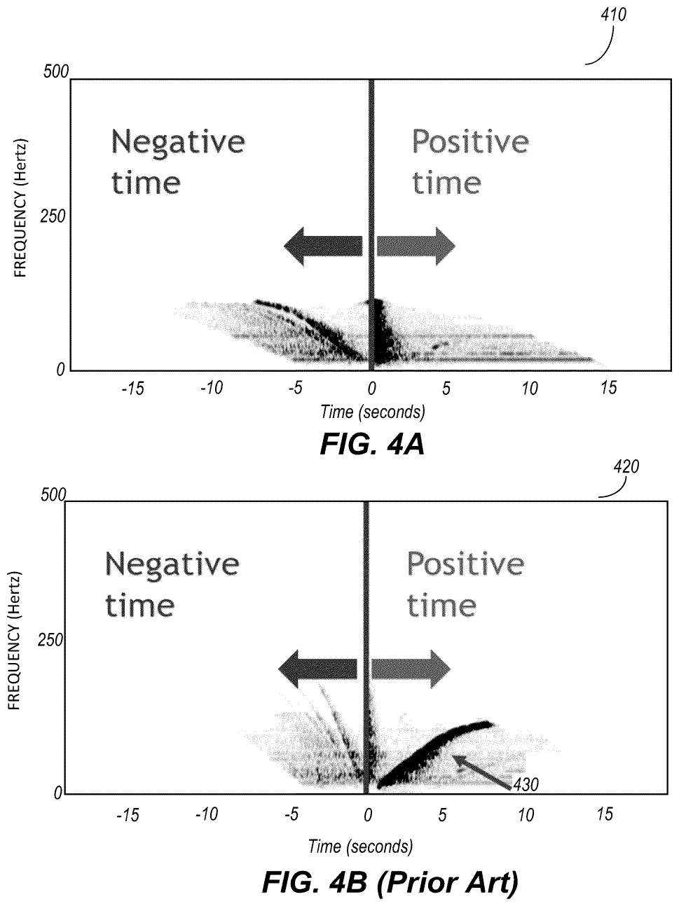

FIGS. 4A-B illustrate recorded seismic data (e.g., recorded seismic data 230 of FIGS. 2C and 3C) correlated with harmonic signals of the ground sweep (e.g., ground sweep 220 of FIGS. 2B and 2C). As illustrated in FIG. 4A, a first set of correlated data 410 is seismic data correlated with the fundamental harmonic signal, such that the recorded seismic data associated with the fundamental harmonic signal (e.g., fundamental order harmonic signal 320 of FIGS. 3B-C) is in the positive direction. Accordingly, seismic data related to harmonic signals higher than the fundamental harmonic signal are pushed to in the negative direction (e.g., negative time) of the first set of correlated data 410, such that these higher order harmonic signals are negated from the recorded seismic data.

In existing systems, an inversion-based method can be used to separate the fundamental (harmonic of order zero) and higher order harmonics from distorted sweeps in the Gabor domain (time-frequency domain). The individual “harmonics signals” separated from the distorted Vibroseis sweep using this inversion-based method enables acquisition of an extended frequency range of seismic data by being independently correlated with the raw seismic data, with no extra acquisition costs. However, the inversion-based method leaves behind artifacts that hinder the imaging with the separated harmonics. This is because, in the time-frequency domain, the correlation with the single harmonic performs a counterclockwise band-passed rotation on the input signal.

FIG. 4B illustrates a second set of correlated data 420 in which seismic data is correlated with the first order harmonic signal (e.g., first order harmonic signal 322 of FIG. 3B). When the conventional inversion-based method is applied to correlate harmonics higher than the fundamental harmonic signal to obtain seismic data with extended frequency information, artifacts related to the low-order harmonic signals compared to the correlated signal become prominent in the positive time region. For example, the correlation of recorded seismic data and the first order harmonic signal has a broader frequency band, but also a strong artifact 430 associated with the fundamental harmonic signal. Artifacts, such as artifact 430 are considered noise, such that removing harmonic related noise provides higher resolution to recorded seismic data using a separation technique as previously provided, while obtaining and maintaining extended frequency information. Table 1 below shows frequency ranges and low-order harmonic noise for correlated harmonic signals.

TABLE 1

| Correlated | | |
|---|---|---|
| sweep | Frequency range | Low-order harmonic noise |
| D⊗H₀ | Depends on the pilot sweep | — |
| | (a~b Hz) | |
| D⊗H₁ | 2 times extended (a~2b Hz) | H₀ related noise |
| D⊗H₂ | 3 times extended (a~3b Hz) | H₀ and H₁ related noise |
| D⊗Hₙ | n + 1 times extended | H₀, H₁, H₂, . . . , Hₙ₋₁ |
| | (a~(n + 1)b Hz) | related noise |

In the table, D represents recorded seismic data, ⊗ represents an operator for correlation, H represents a harmonic signal, n represents the specific order of the harmonic signal, a represent a low end of the frequency range, b represents a high end of the frequency range, and n represents the number of low order harmonic signals. Moreover, “n” is an integer greater than zero.

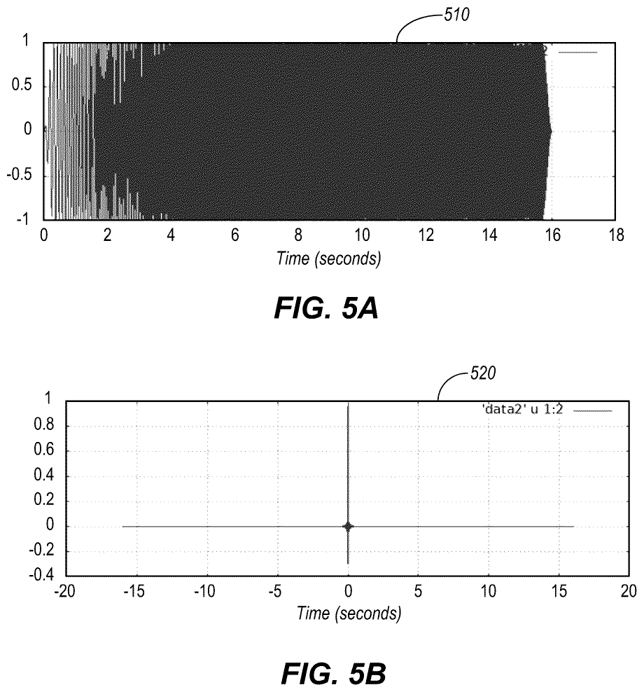

Thus, a signal processor (e.g., the signal processor 164 of FIG. 1) can attenuate or remove the low order harmonic noise associated with correlated harmonic signals, as described in Table 1. For example, the signal processor can obtain the second order harmonic signal by attenuating the fundamental and first order harmonic signals in the recorded seismic data before correlating the recorded seismic data with the second order harmonic signal. Particularly, the signal processor can implement signal processing based on theories involving vibroseis sweeps and correlation theory. For example, FIG. 5A illustrates an example sweep wave 510 in the time domain, which can the pilot sweep, ground sweep, or a harmonic signal. Here, the sweep wave 510 can be a linear sinusoidal signal lasting 16 seconds, with frequency increasing over time (e.g., an up-sweep). Accordingly, energy of the sweep wave 510 is distributed over time. FIG. 5B illustrates an autocorrelated sweep wave 520. Autocorrelation of the sweep wave 510 transforms the sweep wave 510 from a signal that is distributed over time into the autocorrelated sweep wave 520 that is an impulse at a specific time. By employing autocorrelation, as shown in FIG. 5b, a signal processor can focus signals related to a specific desired signal (e.g., a harmonic signal) in the form of impulses at a specific time. Using this autocorrelation process, the signal processor can remove specific signals, such as harmonic signals, from recorded seismic data by correlating the unwanted harmonic signals with the data, concentrating the unwanted signals at a specific time in the time domain, and removing the unwanted signals.

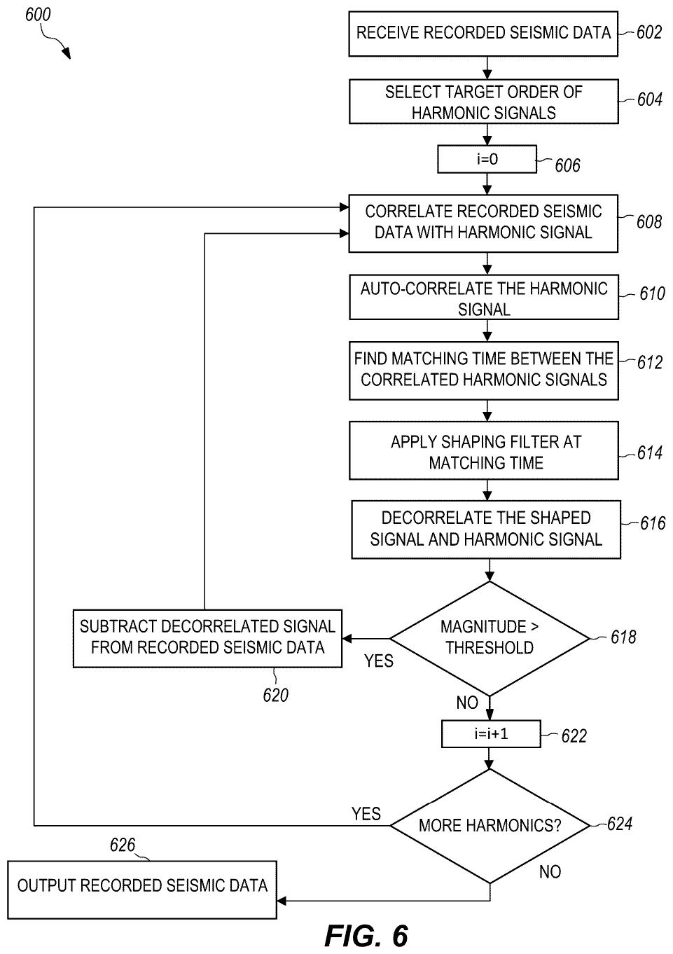

In view of the structural and functional features described above, example methods will be better appreciated with reference to FIGS. 1-5. While, for purposes of simplicity of explanation, the example methods of FIG. 6 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 6 is a flowchart of an example method 600 for removing orders of harmonic signals from recorded seismic data. The method 600 can be implemented by the vibroseis tool 116, and more specifically the signal processor 164, as shown in FIG. 1. Thus, reference can be made to the example of FIGS. 1-5 in the example of FIG. 6. The method 600 can begin at 602 by receiving recorded seismic data (e.g., recorded seismic data 230 of FIGS. 2C and 3C) via the signal processor. For example, the recorded seismic data can be provided to the signal processor by a vibroseis controller (e.g., vibroseis controller 152 of FIG. 1) in response to the vibroseis controller receiving the recorded seismic data from a recording truck (e.g., recording truck 148 of FIG. 1). Particularly, the recorded seismic data is received by the recording truck in response to a vibroseis truck (e.g., vibroseis truck 120) injecting a ground sweep (e.g., ground sweep 132 of FIG. 1 and ground sweep 220 of FIGS. 2C and 3C) in a surface (e.g., surface 128) of the Earth via a metal plate (e.g., the metal plate 124 of FIG. 1). The ground sweep can be injected by the vibroseis truck in response to receiving a pilot sweep (e.g., pilot sweep 210 of FIG. 2A), which can be provided by the vibroseis controller. Accordingly, the vibroseis controller can store each of the pilot sweep, ground sweep, and recorded seismic data in a vibroseis database 156.

At 604, the signal processor selects an order of the harmonic signals to obtain from the recorded seismic data, which can be further stored in the vibroseis database (e.g., vibroseis database 156 of FIG. 1). The signal processor can select the order in response to receiving the selection via the vibroseis controller. Alternatively, the signal processor can select low-order harmonics (e.g., first to sixth order harmonics) or even high order harmonics (e.g., seventh to twelfth order harmonics). For example, the signal processor can select the second order harmonic signal (e.g., H₂). To obtain the second order harmonic, the signal processor removes harmonic signals of lower orders than the second order harmonic signal, including the fundamental order. Because the fundamental order harmonic signal H₀ is removed prior to a higher selected order harmonic signal, the signal processor can set order of harmonic signals to be processed (“i”) to zero at 606, which represents the fundamental order harmonic signal H₀.

At 608, the signal processor correlates the recorded seismic data and the fundamental order harmonic signal of the ground sweep (e.g., D⊗H₀), such that the fundamental harmonic signal of the ground sweep is isolated from other harmonic signals (e.g., FIG. 4A). At 610, the signal processor auto-correlates the fundamental order harmonic signal (e.g., H₀⊗H₀), which transforms the fundamental order harmonic signal to an impulse at a specific time (e.g., FIG. 5B). At 612, the signal processor searches and selects a time that has a greatest match between the harmonic signal correlated with the ground sweep and the auto-correlated fundamental order harmonic signal (e.g., Tₐₘₚ). Accordingly, the signal processor can employ the following expression (1) to compute Tₐₘₚ:

$${T}_{amp} = arg max \{ ( D ⊗ {H}_{0} ) ⊗ ( {H}_{0} ⊗ {H}_{0} ) \} \qquad ( 1 )$$

wherein argmax computes the value (e.g., time) that maximizes Tₐₘₚ as a function of the harmonic signal correlated with the ground sweep (e.g., D⊗H₀) further correlated with the autocorrelated harmonic signal (e.g., H₀⊗H₀). Thus, Tₐₘₚ is a point in time where the harmonic signal correlated with the ground sweep and the auto-correlated fundamental order harmonic signal have the greatest concordance.

The signal processor can apply a shaping filter W that creates an impulse by exponentially attenuating a signal along both positive and negative time axes based on a matching time point T. Thus, at 614, the signal processor produces a shaped signal by applying the shaping filter to the harmonic signal correlated with the ground wave at the time point defined by the autocorrelated fundamental order harmonic signal Tₐₘₚ. For example, the signal processor can employ the following expression (2) to compute the shaped signal:

$${W}_{{T}_{amp}} ( D ⊗ {H}_{0} ) \qquad ( 2 )$$

At 616, the signal processor decorrelates the shaped signal (e.g., W_{T}_{ₐₘₚ}(D⊗H₀) and the harmonic signal to produce a de-correlated signal. At 618, the signal processor determines whether the magnitude of the de-correlated signal is larger than a threshold based on the frequency and duration of the pilot sweep (e.g., pilot sweep 210 of FIG. 2A). If the de-correlated signal is larger than the threshold at 618 (e.g., “YES”), the de-correlated signal is subtracted from the recorded data at 620. Furthermore, steps 604-618 can be repeated so long as the signal processor produces de-correlated signals with a magnitude larger than the threshold, as determined at 618.

If the de-correlated signal has a magnitude that is lower than the threshold at 618 (e.g., “NO”), the signal processor can iterate the order of harmonic signals to be processed (i) by one to process the next order of the harmonic signals toward the selected order of harmonic signals at 622. At 624, the signal process determines whether more harmonic signals are available to be removed based on the order of harmonic signals to be processed at 622 compared to the selected order of harmonic signals at 604. In present example provided for method 600, the fundamental order harmonic signal is removed. However, if the second order harmonic signal is selected at 604, the first and second order harmonic signals would still need to be removed from the recorded seismic data. Thus, at 624, the signal processor can determine whether there are more harmonic signals by comparing the removed harmonic signals to the target harmonic signal selected at 604. More specifically, the processor can compare the order of harmonic signals to be processed (i) at 622 to the target order of harmonic signals selected at 604. If the signal processor determines that there are more harmonic signals at 624 (e.g., “YES”), the signal processor can repeat steps 608-624 for the next order of harmonic signals. That is, if the order of harmonic signals to be processed (i) at 622 is less than the target order of harmonic signals selected at 604, the signal process determine that there are more harmonic signals at 624 (e.g., “YES”).

If the signal processor determines that there are no more harmonic signals at 624 (e.g., “NO”), the signal processor outputs the recorded seismic data at 626. Specifically, the signal processor can determine the order of harmonic signals to be processed (i) at 622 is greater than the selected target order of harmonic signals at 604. Thus, steps 608-624 can be repeated until all harmonics below and including the order of the harmonic signal selected at 604 are removed from the recorded seismic data output by the signal processor at 626. Alternatively, steps 608-624 can be repeated until all low-order harmonics are removed from the recorded seismic data, which is output by the signal processor at 626. More specifically, at 626 the signal processor outputs the recorded seismic after correlating the recorded seismic data with the target order harmonic signal selected at 604.

In an example according to method 600, low-order harmonics can be removed via the following logic code:

```
Target: corr(D, Hₙ)
Loop j = 0, i = 0, n − 1
  Tₐₘₚⁱ = argmax{corr(corr(Dⁱ, Hⱼ), corr(Hⱼ, Hⱼ))}
  While |W_{T}_{ₐₘₚ}ⁱ (corr(Dⁱ, Hⱼ))|/ corr(Hⱼ, Hⱼ) > e
    Dⁱ⁺¹ = Dⁱ − decorr(W_{T}_{ₐₘₚ}ⁱ (corr(Dⁱ, Hⱼ), Hⱼ)
    i = i + 1
    Tₐₘₚⁱ = argmax{corr(corr(Dⁱ, Hⱼ), corr(Hⱼ, Hⱼ))}
  End While
End Loop
Output = corr(Dⁱ, Hₙ)
```

wherein W is the shaping filter, corr(a, b) is the correlation of a and b, decorr(a, b) is the decorrelation of a and b,

$${T}_{amp}^{i}$$

is the matching time, e is the threshold for the energy of noise to be removed and can be a fixed value based on the recorded seismic data such as 2%, and Hⱼ denotes the j^{th} order harmonic signal separated from the ground force.

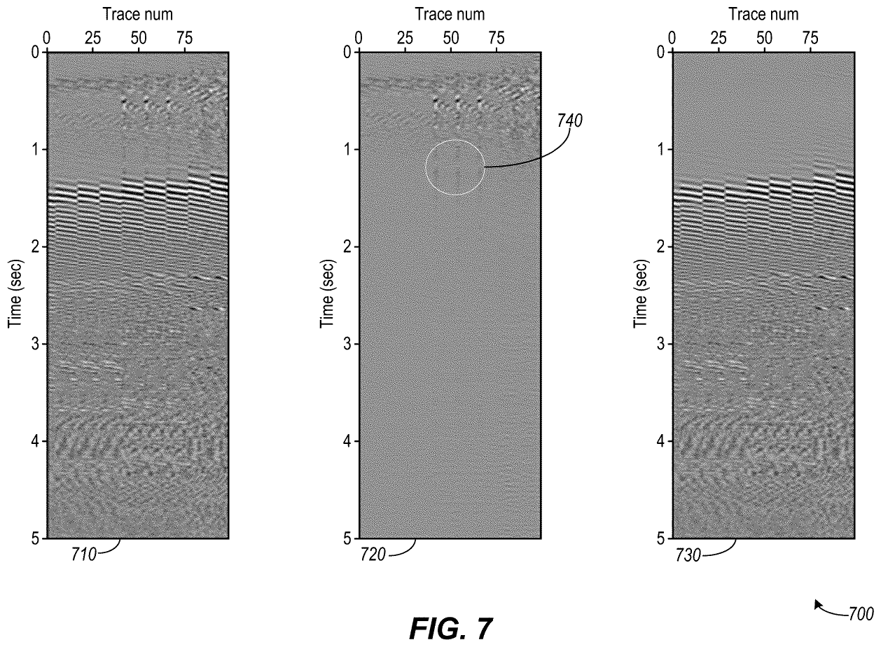

FIG. 7 illustrates examples of recorded seismic data 700. A first set of data 710 is recorded seismic data that includes low order harmonic noise. That is, the first set of data 710 can be the recorded seismic data that is received by the vibroseis controller 152 of FIG. 1. A second set of data 720 is the recorded seismic data without the low order harmonic noise. Specifically, the second set of data 720 is the result of the signal processor (e.g., signal processor 164 of FIG. 1) removing the first order harmonic signal from the recorded seismic data via method 600 of FIG. 6. As illustrated in FIG. 7, the second set of data 720 has less noise and disturbances than the first set of data 710. Thus, the second set of data 720 produced by the signal processor enables details to be discerned from the recorded data, which is not available in the first set of data 710.

A third set of data 730 is the noise removed from the recorded seismic data by the signal processor. As illustrated in the third set of data 730, much of the noise of the recorded seismic data that is removed begins at about 1.2 seconds. Moreover, much of the noise in the third set of data 730 is both present in the first set of data 710 and is almost indistinguishable from the first set of data 710 after about 1.2 seconds. Thus, the recorded seismic data is significantly obscured by the noise in the third set of data 730. By removing the noise of the third set of data 730, the resultant second set of data 720 provides more detailed information. For example, details 740 are discernable in the second set of data 720, but are not present or discernable in the first set of data 710 because the details 740 are obscured by noise of the third set of data 730. That is, details 740 are discernable in the second set of data 720 because the second set of data 720 has higher frequency information that is not masked by the noise of the third set of data 730.

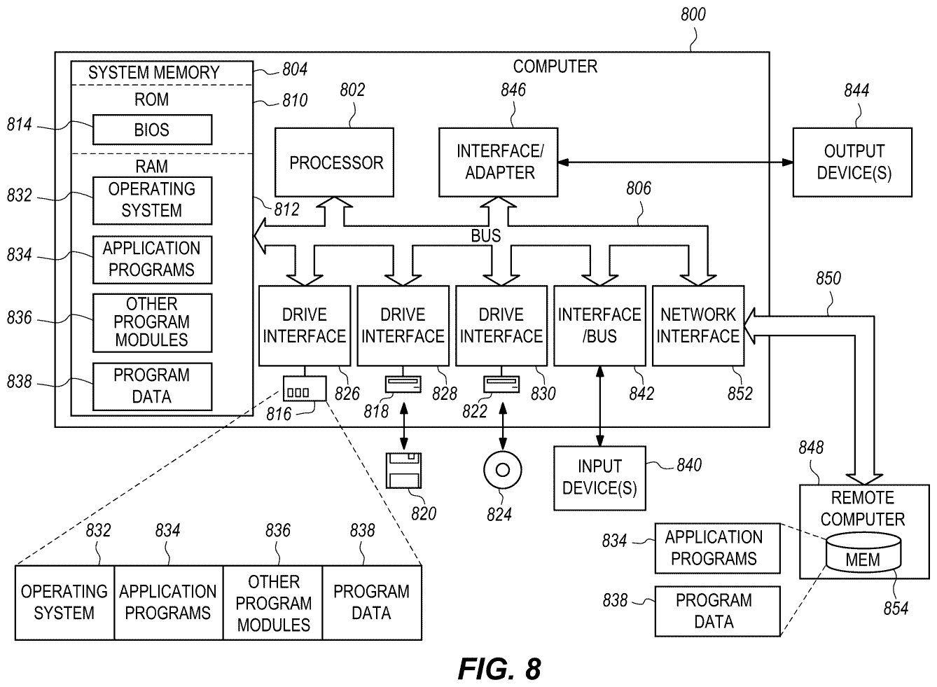

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 8. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 8 illustrates one example of a computer system 800 that can be employed to execute one or more embodiments of the present disclosure. Computer system 800 can be implemented on one or more general purpose networked computer systems, embedded computer systems, routers, switches, server devices, client devices, various intermediate devices/nodes or standalone computer systems. Additionally, computer system 800 can be implemented on various mobile clients such as, for example, a personal digital assistant (PDA), laptop computer, pager, and the like, provided it includes sufficient processing capabilities.

Computer system 800 includes processing unit 802, system memory 804, and system bus 806 that couples various system components, including the system memory 804, to processing unit 802. System memory 804 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 802. System bus 806 may be any of several types of bus structure including a memory bus or memory controller, a peripheral bus, and a local bus using any of a variety of bus architectures. System memory 804 includes read only memory (ROM) 810 and random access memory (RAM) 812. A basic input/output system (BIOS) 814 can reside in ROM 810 containing the basic routines that help to transfer information among elements within computer system 800.

Computer system 800 can include a hard disk drive 816, magnetic disk drive 818, e.g., to read from or write to removable disk 820, and an optical disk drive 822, e.g., for reading CD-ROM disk 824 or to read from or write to other optical media. Hard disk drive 816, magnetic disk drive 818, and optical disk drive 822 are connected to system bus 806 by a hard disk drive interface 826, a magnetic disk drive interface 828, and an optical drive interface 830, respectively. The drives and associated computer-readable media provide nonvolatile storage of data, data structures, and computer-executable instructions for computer system 800. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 812. including operating system 832, one or more application programs 834, other program modules 836, and program data 838. In some examples. the application programs 834 can include a vibroseis tool, vibroseis controller, vibroseis database, and signal processor. The program data 838 can include a pilot sweep, ground sweep, and seismic data in various domains, as well as seismic data processed by the signal processor with attenuated low order harmonic noise. The application programs 834 and program data 838 can include functions and methods programmed to attenuate the low order harmonic noise of the recorded seismic data, such as shown and described herein.

A user may enter commands and information into computer system 800 through one or more input devices 840, such as a pointing device (e.g., a mouse, touch screen), keyboard, microphone, joystick, game pad, scanner, and the like. For instance, the user can employ input device 840 to edit or modify select an order of the harmonic signals, adjust a threshold value employed by the signal processor for decorrelation. These and other input devices 840 are often connected to processing unit 802 through a corresponding port interface 842 that is coupled to the system bus, but may be connected by other interfaces, such as a parallel port, serial port, or universal serial bus (USB). One or more output devices 844 (e.g., display, a monitor, printer, projector, or other type of displaying device) is also connected to system bus 806 via interface 846, such as a video adapter.

Computer system 800 may operate in a networked environment using logical connections to one or more remote computers, such as remote computer 848. Remote computer 848 may be a workstation, computer system, router, peer device, or other common network node, and typically includes many or all the elements described relative to computer system 800. The logical connections, schematically indicated at 850, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 800 can be connected to the local network through a network interface or adapter 852. When used in a WAN networking environment, computer system 800 can include a modem, or can be connected to a communications server on the LAN. The modem, which may be internal or external, can be connected to system bus 806 via an appropriate port interface. In a networked environment, application programs 834 or program data 838 depicted relative to computer system 800, or portions thereof, may be stored in a remote memory storage device 854.

Embodiments disclosed herein include:

A. A method for attenuating low order harmonic noise in recorded seismic data comprising receiving the recorded seismic data in response to vibroseis operations injecting a ground sweep into the Earth based on a pilot sweep, wherein the ground sweep and recorded seismic data include low order harmonic noise based on non-linearities associated with the vibroseis operations; attenuating a fundamental order harmonic signal of the ground sweep and attenuating a given harmonic signal by correlating the given harmonic signal of the ground sweep with the recorded seismic data; autocorrelating the given harmonic signal of the ground sweep; finding and selecting a matching time between the autocorrelated given harmonic signal and the given harmonic signal correlated with the recorded seismic data; decorrelating the given harmonic signal of the ground sweep with the recorded seismic data based on the matching time to generate a decorrelated signal; and subtracting the decorrelated signal from the recorded seismic data.

B. A machine-readable storage medium having stored thereon a computer program for attenuating low order harmonic noise in recorded seismic data, the computer program comprising a routine of set instructions for causing the machine to perform the steps of receiving the recorded seismic data in response to vibroseis operations injecting a ground sweep into the Earth based on a pilot sweep, wherein the ground sweep and recorded seismic data include low order harmonic noise based on non-linearities associated with the vibroseis operations attenuating a fundamental order harmonic signal of the ground sweep and attenuating a given harmonic signal by correlating the given harmonic signal of the ground sweep with the recorded seismic data autocorrelating the given harmonic signal of the ground sweep; finding and selecting a matching time between the autocorrelated given harmonic signal and the given harmonic signal correlated with the recorded seismic data; decorrelating the given harmonic signal of the ground sweep with the recorded seismic data based on the matching time to generate a decorrelated signal; and subtracting the decorrelated signal from the recorded seismic data.

C. A vibroseis tool for attenuating low order harmonic noise in recorded seismic data, the vibroseis tool comprising a vibroseis controller configured to receive the recorded seismic data in response to vibroseis operations injecting a ground sweep into the Earth based on a pilot sweep, wherein the ground sweep and recorded seismic data include low order harmonic noise based on non-linearities associated with the vibroseis operations; a vibroseis database operable to store the pilot sweep, ground sweep, and recorded seismic data; a signal processor configured to attenuate a fundamental order harmonic signal of the ground sweep and attenuate a given harmonic signal by correlating the given harmonic signal of the ground sweep with the recorded seismic data; autocorrelating the given harmonic signal of the ground sweep; finding and selecting a matching time between the autocorrelated given harmonic signal and the given harmonic signal correlated with the recorded seismic data; decorrelating the given harmonic signal of the ground sweep with the recorded seismic data based on the matching time to generate a decorrelated signal; subtracting the decorrelated signal from the recorded seismic data in response to determining that a magnitude of the decorrelated signal is greater than a threshold value; and attenuating the given harmonic signal again in response to subtracting the decorrelated signal from the recorded seismic data.

Each of embodiments A through C may have one or more of the following additional elements in any combination: Element 1: wherein attenuating the given harmonic signal further comprises applying a shaping filter to the given harmonic signal correlated with the ground wave at the matching time to produce a shaped signal, such that the decorrelated signal is generated by decorrelating the shaped signal with the recorded seismic data. Element 2: wherein the decorrelated signal is subtracted from the recorded seismic data in response to determining that a magnitude of the decorrelated signal is greater than a threshold value. Element 3: wherein the given harmonic signal is attenuated in response to subtracting the decorrelated signal from the recorded seismic data. Element 4: further comprising selecting a first order harmonic signal.

Element 5: further comprising attenuating the first order harmonic signal in response to attenuating the fundamental order harmonic signal. Element 6: wherein the first order harmonic signal is attenuated in response to determining that the decorrelated signal associated with the fundamental order harmonic signal has a magnitude less than the threshold. Element 7: further comprising outputting recorded seismic data with attenuated fundamental and first order harmonic signals in response to attenuating the first order harmonic signal. Element 8: further comprising selecting a second order harmonic signal. Element 9: further comprising attenuating the first and second order harmonic signals. Element 10: wherein the first order harmonic signal is attenuated in response to attenuating the fundamental order harmonic signal, and the second order harmonic signal is attenuated in response to attenuating the first order harmonic signal.

Element 11: wherein attenuating the given order harmonic signal further comprises applying a shaping filter to the given harmonic signal correlated with the ground wave at the matching time to produce a shaped signal, such that the decorrelated signal is generated by decorrelating the shaped signal with the recorded seismic data; wherein the decorrelated signal is subtracted from the recorded seismic data in response to determining that a magnitude of the decorrelated signal is greater than a threshold value, and the given order harmonic signal is attenuated in response to subtracting the decorrelated signal from the recorded seismic data.

Element 12: the set of instructions further causing the machine to perform the step of selecting a second order harmonic signal. Element 13: the set of instructions further causing the machine to perform the steps of attenuating the first and second order harmonic signals. Element 14: wherein the first order harmonic signal is attenuated in response to attenuating the fundamental order harmonic signal, and the second order harmonic signal is attenuated in response to attenuating the first order harmonic signal.

Element 15: wherein the signal processor attenuates a first order harmonic signal in response to determining that the magnitude of the decorrelated signal associated with the fundamental order harmonic signal is less than the threshold value. Element 16: wherein the signal processor stores the recorded seismic data in response to removing the low order harmonic noise associated with the first and fundamental order harmonic signals in the vibroseis database. Element 17: wherein the vibroseis controller deploys extraction equipment in response to the signal processor storing the recorded seismic data in response to removing the low order harmonic noise associated with the first and fundamental order harmonic signals in the vibroseis database.

By way of non-limiting example, exemplary combinations applicable to A through C include: Element 1 with Element 2; Element 2 with Element 3; Element 3 with Element 4; Element 4 with Element 5; Element 4 with Element 6; Element 6 with Element 7; Element 3 with Element 8; Element 8 with Element 9; Element 9 with Element 10; Element 11 with Element 12; Element 12 with Element 13; Element 13 with Element 14; Element 15 with Element 16; and Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A method for attenuating low order harmonic noise in recorded seismic data comprising:
receiving the recorded seismic data in response to vibroseis operations injecting a ground sweep into the Earth based on a pilot sweep, wherein the ground sweep and recorded seismic data include low order harmonic noise based on non-linearities associated with the vibroseis operations;
attenuating a fundamental order harmonic signal of the ground sweep and attenuating a given harmonic signal by:
correlating the given harmonic signal of the ground sweep with the recorded seismic data;
autocorrelating the given harmonic signal of the ground sweep;
finding and selecting a matching time between the autocorrelated given harmonic signal and the given harmonic signal correlated with the recorded seismic data;
decorrelating the given harmonic signal of the ground sweep with the recorded seismic data based on the matching time to generate a decorrelated signal; and
subtracting the decorrelated signal from the recorded seismic data.

2. The method of claim 1, wherein attenuating the given harmonic signal further comprises applying a shaping filter to the given harmonic signal correlated with the ground wave at the matching time to produce a shaped signal, such that the decorrelated signal is generated by decorrelating the shaped signal with the recorded seismic data.

3. The method of claim 2, wherein the decorrelated signal is subtracted from the recorded seismic data in response to determining that a magnitude of the decorrelated signal is greater than a threshold value.

4. The method of claim 3, wherein the given harmonic signal is attenuated in response to subtracting the decorrelated signal from the recorded seismic data.

5. The method of claim 4, further comprising selecting a first order harmonic signal.

6. The method of claim 5, further comprising attenuating the first order harmonic signal in response to attenuating the fundamental order harmonic signal.

7. The method of claim 5, wherein the first order harmonic signal is attenuated in response to determining that the decorrelated signal associated with the fundamental order harmonic signal has a magnitude less than the threshold.

8. The method of claim 7, further comprising outputting recorded seismic data with attenuated fundamental and first order harmonic signals in response to attenuating the first order harmonic signal.

9. The method of claim 4, further comprising selecting a second order harmonic signal.

10. The method of claim 9, further comprising attenuating the first and second order harmonic signals.

11. The method of claim 10, wherein the first order harmonic signal is attenuated in response to attenuating the fundamental order harmonic signal, and the second order harmonic signal is attenuated in response to attenuating the first order harmonic signal.

12. A machine-readable storage medium having stored thereon a computer program for attenuating low order harmonic noise in recorded seismic data, the computer program comprising a routine of set instructions for causing the machine to perform the steps of:
receiving the recorded seismic data in response to vibroseis operations injecting a ground sweep into the Earth based on a pilot sweep, wherein the ground sweep and recorded seismic data include low order harmonic noise based on non-linearities associated with the vibroseis operations;
attenuating a fundamental order harmonic signal of the ground sweep and attenuating a given harmonic signal by:
correlating the given harmonic signal of the ground sweep with the recorded seismic data;
autocorrelating the given harmonic signal of the ground sweep;
finding and selecting a matching time between the autocorrelated given harmonic signal and the given harmonic signal correlated with the recorded seismic data;
decorrelating the given harmonic signal of the ground sweep with the recorded seismic data based on the matching time to generate a decorrelated signal; and
subtracting the decorrelated signal from the recorded seismic data.

13. The machine-readable storage medium of claim 12, wherein attenuating the given order harmonic signal further comprises:
applying a shaping filter to the given harmonic signal correlated with the ground wave at the matching time to produce a shaped signal, such that the decorrelated signal is generated by decorrelating the shaped signal with the recorded seismic data;
wherein the decorrelated signal is subtracted from the recorded seismic data in response to determining that a magnitude of the decorrelated signal is greater than a threshold value, and the given order harmonic signal is attenuated in response to subtracting the decorrelated signal from the recorded seismic data.

14. The machine-readable storage medium of claim 13, the set of instructions further causing the machine to perform the step of selecting a second order harmonic signal.

15. The machine-readable storage medium of claim 14, the set of instructions further causing the machine to perform the steps of attenuating the first and second order harmonic signals.

16. The machine-readable storage medium of claim 15, wherein the first order harmonic signal is attenuated in response to attenuating the fundamental order harmonic signal, and the second order harmonic signal is attenuated in response to attenuating the first order harmonic signal.

17. A vibroseis tool for attenuating low order harmonic noise in recorded seismic data, the vibroseis tool comprising:
a vibroseis controller configured to receive the recorded seismic data in response to vibroseis operations injecting a ground sweep into the Earth based on a pilot sweep, wherein the ground sweep and recorded seismic data include low order harmonic noise based on non-linearities associated with the vibroseis operations;
a vibroseis database operable to store the pilot sweep, ground sweep, and recorded seismic data;
a signal processor configured to attenuate a fundamental order harmonic signal of the ground sweep and attenuate a given harmonic signal by:
correlating the given harmonic signal of the ground sweep with the recorded seismic data;
autocorrelating the given harmonic signal of the ground sweep;
finding and selecting a matching time between the autocorrelated given harmonic signal and the given harmonic signal correlated with the recorded seismic data;
decorrelating the given harmonic signal of the ground sweep with the recorded seismic data based on the matching time to generate a decorrelated signal;
subtracting the decorrelated signal from the recorded seismic data in response to determining that a magnitude of the decorrelated signal is greater than a threshold value; and
attenuating the given harmonic signal again in response to subtracting the decorrelated signal from the recorded seismic data.

18. The vibroseis tool of claim 17, wherein the signal processor attenuates a first order harmonic signal in response to determining that the magnitude of the decorrelated signal associated with the fundamental order harmonic signal is less than the threshold value.

19. The vibroseis tool of claim 18, wherein the signal processor stores the recorded seismic data in response to removing the low order harmonic noise associated with the first and fundamental order harmonic signals in the vibroseis database.

20. The vibroseis tool of claim 19, wherein the vibroseis controller deploys extraction equipment in response to the signal processor storing the recorded seismic data in response to removing the low order harmonic noise associated with the first and fundamental order harmonic signals in the vibroseis database.
